(19) United States
(12) Patent Application Publication
(10) Pub. No.: US 2021/0064307 A1
(43) Pub. Date: Mar. 4, 2021

(54) IMAGE PRINTING SYSTEM, IMAGE PRINTING APPARATUS, AND NON-TRANSITORY COMPUTER READABLE MEDIUM

(71) Applicant: FUJI XEROX CO., LTD., Tokyo (JP)

(72) Inventor: Kazuko KIRIHARA, Kanagawa (JP)

(73) Assignee: FUJI XEROX CO., LTD., Tokyo (JP)

(21) Appl. No.: 16/776,510

(22) Filed: Jan. 30, 2020

(30) Foreign Application Priority Data
Aug. 28, 2019 (JP) 2019-155880

(51) Int. Cl. G06F 3/12; G06K 15/00; G06K 15/02

(52) U.S. Cl. CPC G06F 3/1228; G06F 3/1205; G06K 15/1867; G06K 15/007

(57) ABSTRACT

An image printing system includes a portable terminal and an image printing apparatus. The portable terminal includes a first processor configured to transmit, via transmission software that is capable of performing transmission without using a device driver that allows the portable terminal to control a printing function of the image printing apparatus, location information indicating location of content and a printing instruction for printing the content. The image printing apparatus includes a second processor configured to receive, via reception software corresponding to the transmission software, the location information and the printing instruction from the portable terminal, acquire the content identified by the location information, and print the acquired content in accordance with the printing instruction.

### CROSS-REFERENCE TO RELATED APPLICATIONS

This application is based on and claims priority under 35 USC 119 from Japanese Patent Application No. 2019-155880 filed Aug. 28, 2019.

### BACKGROUND

### (i) Technical Field

The present disclosure relates to an image printing system, an image printing apparatus, and a non-transitory computer readable medium.

### (ii) Related Art

In Japanese Unexamined Patent Application Publication No. 2008-040991, a printing system is disclosed. The printing system includes a web server that manages a website on a network, a terminal that includes a function for accessing the website via the network, a printer that includes a function for performing data communication via the network and prints input data, and a print server that is connected to the network. The terminal includes printing instruction transmitting means for transmitting printing instruction information including access information for accessing content data to be printed in the website to the print server. The print server includes print data acquiring means for accessing the web server in accordance with the access information included in the printing instruction information from the terminal and acquiring the content data to be printed and print data transmitting means for transmitting the acquired content data to the printer.

### SUMMARY

To cause content (a map or the like) being browsed on a terminal (for example, a portable terminal) to be printed with an image printing apparatus such as a printer or a multifunction apparatus, the image printing apparatus needs to be preset. Presetting for the image printing apparatus is, for example, installing a device driver in advance in the image printing apparatus.

Aspects of non-limiting embodiments of the present disclosure relate to providing an image printing system, an image printing apparatus, and a non-transitory computer readable medium that are capable of causing content being browed on a portable terminal to be printed with the image printing apparatus without performing presetting for the image printing apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image printing system including a portable terminal and an image printing apparatus. The portable terminal includes a first processor configured to transmit, via transmission software that is capable of performing transmission without using a device driver that allows the portable terminal to control a printing function of the image printing apparatus, location information indicating location of content and a printing instruction for printing the content. The image printing apparatus includes a second processor configured to receive, via reception software corresponding to the transmission software, the location information and the printing instruction from the portable terminal, acquire the content identified by the location information, and print the acquired content in accordance with the printing instruction.

### BRIEF DESCRIPTION OF THE DRAWINGS

Exemplary embodiments of the present disclosure will be described in detail based on the following figures, wherein:

FIG. 1 illustrates a configuration of an image printing system according to a first exemplary embodiment;

FIG. 2 illustrates a configuration of a multifunction apparatus according to the first exemplary embodiment;

FIG. 3 is a functional block diagram of the multifunction apparatus according to the first exemplary embodiment;

FIG. 4 illustrates a configuration of a portable terminal according to the first exemplary embodiment;

FIG. 5 is a functional block diagram of the portable terminal according to the first exemplary embodiment;

FIG. 6 illustrates content and components in the first exemplary embodiment;

FIG. 7 is a flowchart illustrating an operation of the image printing system according to the first exemplary embodiment;

FIG. 8 is a flowchart illustrating an operation of an image printing system according to a second exemplary embodiment;

FIG. 9A illustrates a state of a component displayed on a portable terminal in the second exemplary embodiment;

FIG. 9B illustrates printing based on a printing policy “print directly” in the second exemplary embodiment;

FIG. 9C illustrates printing based on a printing policy “print with a paper size for a multifunction apparatus”;

FIG. 9D illustrates printing based on a printing policy “print with a physical size for a portable terminal”;

FIG. 10A illustrates another state of a component displayed on the portable terminal in the second exemplary embodiment; and

FIG. 10B illustrates printing based on a printing policy “partly” in the second exemplary embodiment.

### DETAILED DESCRIPTION

An image printing system according to exemplary embodiments of the present disclosure will be described below with reference to drawings.

### First Exemplary Embodiment

### Configuration of First Exemplary Embodiment

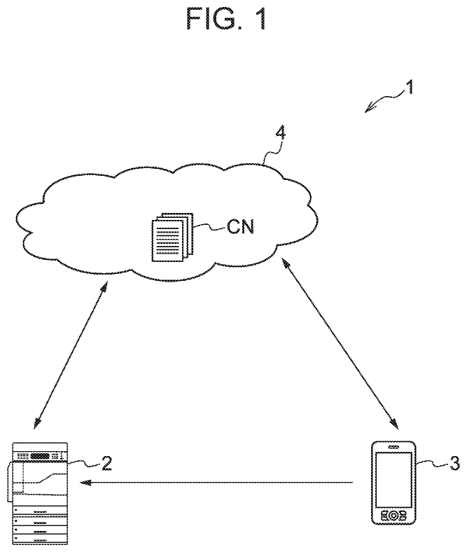

FIG. 1 illustrates a configuration of an image printing system according to a first exemplary embodiment. The configuration of the image printing system according to the first exemplary embodiment will be described below with reference to FIG. 1.

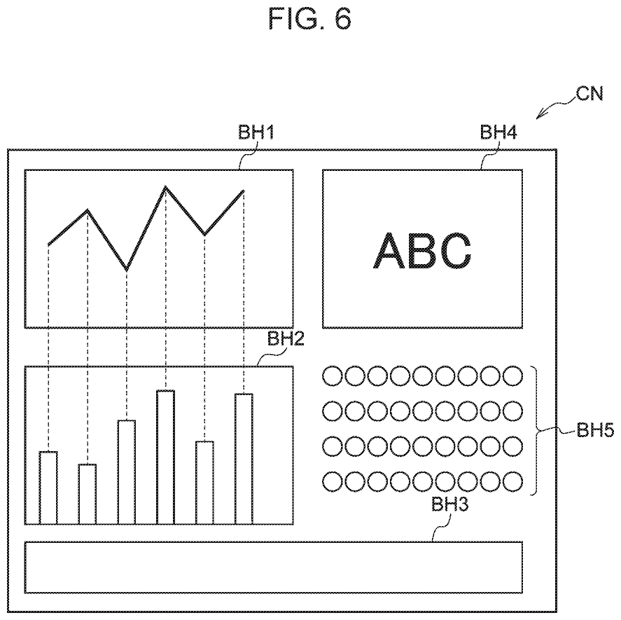

An image printing system 1 according to the first exemplary embodiment includes, as illustrated in FIG. 1, a multifunction apparatus 2, a portable terminal 3, and a cloud 4 so that the portable terminal 3 may cause the multifunction apparatus 2 to print content CN (for example, a homepage) and components BH1 to BH5 (illustrated in FIG. 6) configuring the content CN stored on the cloud 4.

### <Configuration Multifunction Apparatus>

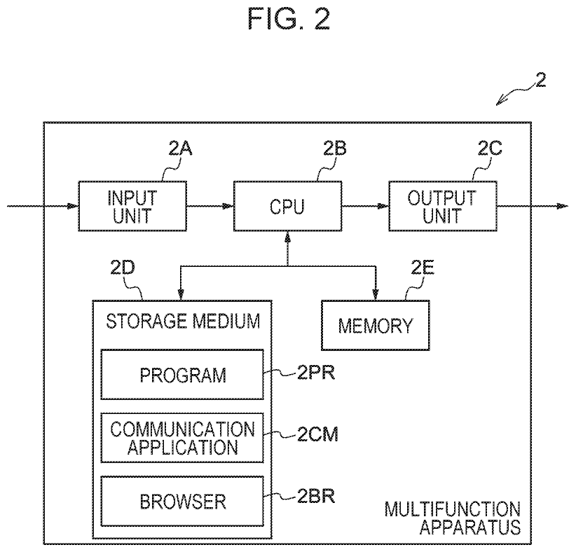

FIG. 2 illustrates a configuration of a multifunction apparatus according to the first exemplary embodiment.

The multifunction apparatus 2 includes, as illustrated in FIG. 2, an input unit 2A, a central processing unit (CPU) 2B, an output unit 2C, a storage medium 2D, and a memory 2E. The input unit 2A includes, for example, a scanner. The CPU 2B is an example of a second processor and is the well-known core of a computer that causes hardware to operate in accordance with software. The output unit 2C includes, for example, a printer.

The storage medium 2D includes, for example, a hard disk drive (HDD), a solid state drive (SSD), and a read only memory (ROM). The memory 2E includes, for example, a dynamic random access memory (DRAM) and a static random access memory (SRAM).

As illustrated in FIG. 2, the storage medium 2D stores therein a program 2PR, a communication application 2CM, and a browser 2BR. The program 2PR is an instruction group for defining contents of processing to be performed by the multifunction apparatus 2. The communication application 2CM is an example of “reception software”. The browser 2BR is an example of widely known software for browsing homepages or the like on the Internet.

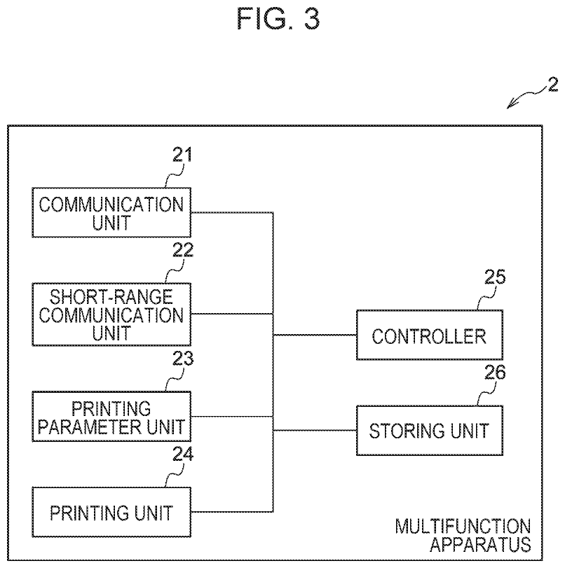

The communication application 2CM is capable of transmitting, for example, a uniform resource location (URL) as an example of location information indicating the location of the content CN and a printing instruction for printing the content CN to the multifunction apparatus 2, without using a device driver (for example, a printer driver) for controlling a printing function of a printing unit 24 (illustrated in FIG. 3) in the multifunction apparatus 2. The communication application 2CM performs communication through, for example, near field communication (NFC), ZigBee, or the like.

FIG. 3 is a functional block diagram of the multifunction apparatus according to the first exemplary embodiment.

The multifunction apparatus 2 according to the first exemplary embodiment includes, as illustrated in FIG. 3, a communication unit 21, a short-range communication unit 22, a printing parameter unit 23, a printing unit 24, a controller 25, and a storing unit 26.

Regarding the relationship of the hardware configuration and functional configuration of the multifunction apparatus 2, on the hardware, the CPU 2B executes the program 2PR stored in the storage medium 2D using the memory 2E and controls operations of the input unit 2A and the output unit 2C as necessary. Accordingly, functions of the communication unit 21, the short-range communication unit 22, the printing parameter unit 23, and the printing unit 24 are implemented, and monitoring and control of operations of the above-mentioned units by the controller 25 are implemented. Details of the functions of the units mentioned above will be described later.

### <Configuration of Portable Terminal>

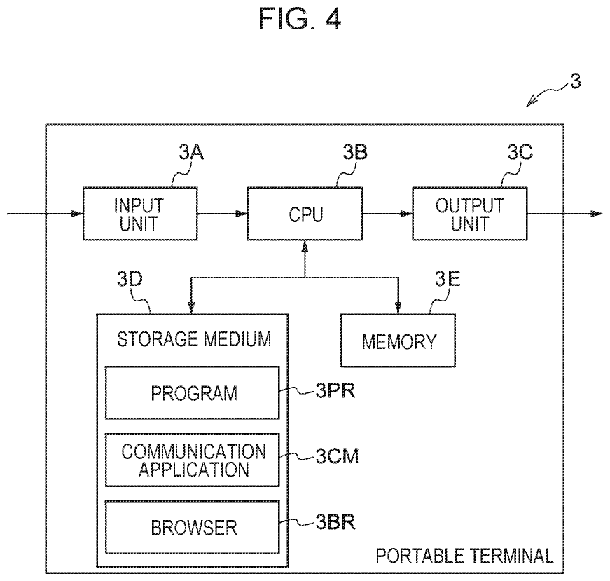

FIG. 4 illustrates a configuration of the portable terminal according to the first exemplary embodiment.

The portable terminal 3 includes, as illustrated in FIG. 4, an input unit 3A, a CPU 3B, an output unit 3C, a storage medium 3D, and a memory 3E. The input unit 3A includes, for example, a touch panel and an input key. As with the CPU 2B mentioned above (illustrated in FIG. 2), the CPU 3B is an example of a first processor and is the well-known core of a computer that causes hardware to operate in accordance with software. The output unit 3C includes, for example, a liquid crystal panel and a speaker.

As with the storage medium 2D mentioned above (illustrated in FIG. 2), the storage medium 3D includes, for example, an HDD, an SSD, and a ROM. As with the memory 2E mentioned above (illustrated in FIG. 2), the memory 3E includes, for example, a DRAM and an SRAM.

As with the storage medium 2D mentioned above, the storage medium 3D stores therein a program 3PR, a communication application 3CM, and a browser 3BR, as illustrated in FIG. 4. The program 3PR is an instruction group for defining contents of processing to be performed by the portable terminal 3. The communication application 3CM is an example of “transmission software”. The browser 3BR is an example of “browsing software”.

The communication application 3CM corresponds to the communication application 2CM in the multifunction apparatus 2 (illustrated in FIG. 2). The communication application 3CM receives, for example, the URL of the above-mentioned content CN to be printed and a printing instruction for printing the content CN, without using a device driver (for example, a printer driver) for controlling the printing function of the printing unit 24 in the multifunction apparatus 2 (illustrated in FIG. 3) from the communication application 2CM.

As with the above-mentioned browser 2BR (illustrated in FIG. 2), the browser 3BR is software for browsing homepages or the like on the Internet.

### <Relationship Between Communication Application and Browser>

Regarding the relationship of the communication application 3CM and the browser 3BR, it is desirable that, for example, the communication application 3CM be plugged in (mounted in) the browser 3BR. Accordingly, information obtained earlier by the browser 3BR (for example, the URL of the content CN) is shared with the communication application 3CM later.

Regarding the relationship between the communication application 3CM and the browser 3BR, the communication application 3CM may be externally attached to the browser 3BR, instead of being plugged in the browser 3BR. Accordingly, information (for example, the URL of the content CN) obtained earlier by the browser 3BR is shared by the communication application 3CM later.

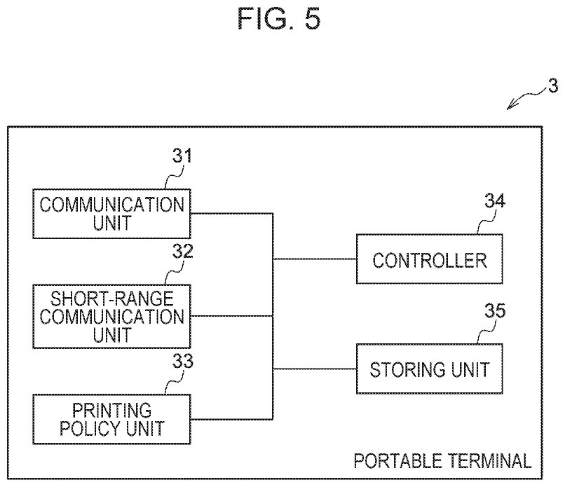

FIG. 5 is a functional block diagram of the portable terminal according to the first exemplary embodiment.

The portable terminal 3 includes, as illustrated in FIG. 5, a communication unit 31, a short-range communication unit 32, a printing policy unit 33, a controller 34, and a storing unit 35.

Regarding the relationship of the hardware configuration and functional configuration of the portable terminal 3, on the hardware, the CPU 3B executes the program 3PR stored in the storage medium 3D using the memory 3E and controls operations of the input unit 3A and the output unit 3C as necessary. Accordingly, functions of the communication unit 31, the short-range communication unit 32, and the printing policy unit 33 are implemented, and monitoring and control of operations of the above-mentioned units by the controller 34 are implemented. Details of the functions of the units mentioned above will be described later.

### <Configuration of Cloud>

Referring back to FIG. 1, the cloud 4 is, for example, a server on the Internet. As illustrated in FIG. 6, for example, the content CN that is able to be browsed on the Internet is stored in the cloud 4. The content CN includes the components BH1 to BH5. Each of the components BH1 to BH5 is, for example, an image such as a graph, characters, or the like. The content CN itself includes an URL, which is information indicating the location of the content, and the components BH1 to BH5 include corresponding URLs, which are information indicating locations of the components BH1 to BH5. Accordingly, by specifying the URL of the content CN, the entire content CN may be printed. In contrast, by specifying the URL of each of the components BH1 to BH5, the components BH1 to BH5 may be printed individually.

### Operation of First Exemplary Embodiment

An operation of the image printing system according to the first exemplary embodiment will be described.

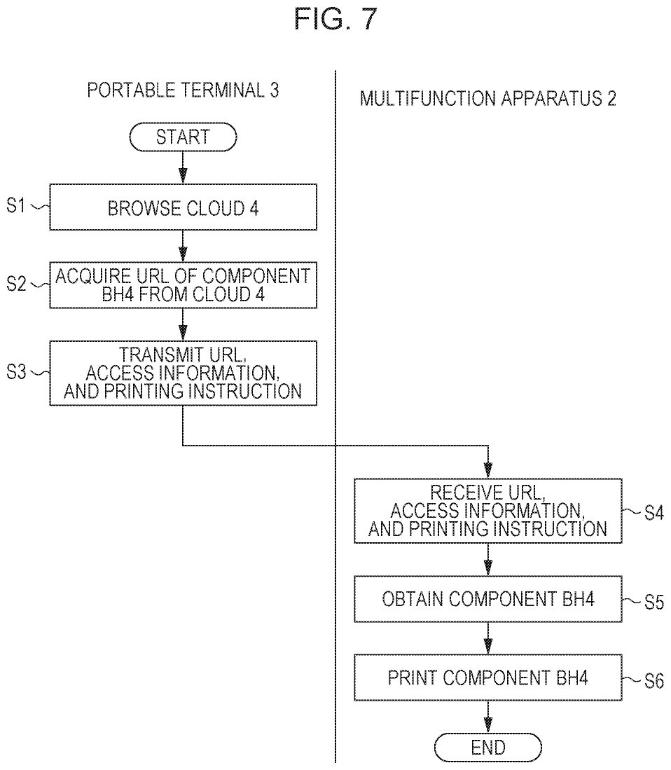

FIG. 7 is a flowchart illustrating the operation of the image printing system according to the first exemplary embodiment. The operation of the image printing system according to the first exemplary embodiment will be described below with reference to the flowchart illustrated in FIG. 7.

Hereinafter, to browse the content CN (illustrated in FIGS. 1 and 6), it is assumed that access information (an ID number and a password of a user of the portable terminal 3) need to be transmitted to the cloud 4. Furthermore, it is assumed that the user of the portable terminal 3 does not desire to print the entire content CN but desires to print only the component BH4 in the content CN.

Step S1: In the portable terminal 3 (illustrated in FIG. 1), the CPU 3B (illustrated in FIG. 4) functioning as the communication unit 31 (illustrated in FIG. 5) browses the cloud 4. That is, the CPU 3B accesses the cloud 4 via the browser 3BR (illustrated in FIG. 4), and transmits the URL and access information of the content CN (illustrated in FIGS. 1 and 6), which are input by the user of the portable terminal 3, to the cloud 4. Accordingly, the user of the portable terminal 3 browses the content CN (illustrated in FIG. 6).

Step S2: The user of the portable terminal 3 who is browsing the content CN issues to the portable terminal 3 an instruction for acquiring the URL of the component BH4. Then, the CPU 3B of the portable terminal 3 functioning as the communication unit 31 (illustrated in FIG. 5) acquires, via the browser 3BR, the URL of the component BH4 from the cloud 4.

Step S3: When the URL of the component BH4 is acquired, the user of the portable terminal 3 inputs a printing instruction, which is an instruction for causing the multifunction apparatus 2 to print the component BH4, to the portable terminal 3. In other words, the input unit 3A receives the printing instruction from the user of the portable terminal 3. Then, the user of the portable terminal 3 holds the short-range communication unit 32 of the portable terminal 3 (illustrated in FIG. 5) over the short-range communication unit 22 (illustrated in FIG. 3) of the multifunction apparatus 2 (illustrated in FIG. 1). Accordingly, in the portable terminal 3, the CPU 3B functioning as the short-range communication unit 32 transmits, via the communication application 3CM (illustrated in FIG. 4,) the URL of the content CN input by the user, the URL of the component BH4 acquired from the cloud 4, and the access information and the printing instruction input by the user of the portable terminal 3 to the multifunction apparatus 2.

Step S4: In the multifunction apparatus 2, the CPU 2B (illustrated in FIG. 2) functioning as the short-range communication unit 22 receives, via the communication application 2CM (illustrated in FIG. 2), the URL of the content CN, the URL of the component BH4, the access information, and the printing instruction from the portable terminal 3.

Step S5: In the multifunction apparatus 2, the CPU 2B functioning as the communication unit 21 (illustrated in FIG. 3) accesses, via the browser 2BR (illustrated in FIG. 2), the cloud 4 according to the URL of the content CN, the URL of the component BH4, and the access information received from the portable terminal 3, and thus obtains the component BH4 stored in the cloud 4.

Step S6: In the multifunction apparatus 2, the CPU 2B functioning as the printing unit 24 (illustrated in FIG. 3) prints the component BH4 on a printing medium (for example, printing paper) in accordance with the printing instruction received from the portable terminal 3.

As described above, in the image printing system 1 according to the first exemplary embodiment, at the portable terminal 3, the short-range communication unit 32 transmits the URL of the content CN, the URL of the component BH4, the access information of the content CN, and the printing instruction to the multifunction apparatus 2, with the use of the communication application 3CM that is capable of performing transmission without using a device driver for controlling the printing function of the printing unit 24 of the multifunction apparatus 2, that is, without using a printer driver for controlling the printing function of the printing unit 24 of the multifunction apparatus 2.

Meanwhile, at the multifunction apparatus 2, the short-range communication unit 22 receives, via the communication application 2CM corresponding to the communication application 3CM of the portable terminal 3, the URL of the content CN, the URL of the component BH4, the access information of the content CN, and the printing instruction. Furthermore, at the multifunction apparatus 2, the communication unit 21 obtains, via the browser 2BR, the component BH4 from the cloud 4 according to the URL of the content CN, the URL of the component BH4, and the access information of the content CN, and the printing unit 24 prints the component BH4 in accordance with the printing instruction received from the portable terminal 3.

Accordingly, at the portable terminal 3, there is no need to perform presetting for the multifunction apparatus 2. That is, there is no need to install a printer driver, which is a device driver, into the portable terminal 3 to perform various settings regarding the printing function of the multifunction apparatus 2 in advance.

### Second Exemplary Embodiment

An image printing system according to a second exemplary embodiment will be described below.

In the image printing system 1 according to the second exemplary embodiment, unlike the image printing system 1 according to the first exemplary embodiment, the multifunction apparatus 2 performs printing of the component BH4 in accordance with a printing parameter determined based on a printing policy set by the portable terminal 3. Details of the printing policy and the printing parameter will be described later.

### Configuration of Second Exemplary Embodiment

The configuration of the image printing system 1 according to the second exemplary embodiment is the same as the configuration of the image printing system 1 according to the first exemplary embodiment, which is illustrated in FIG. 1. The configuration of the multifunction apparatus 2 according to the second exemplary embodiment is the same as the configuration of the multifunction apparatus 2 according to the first exemplary embodiment, which is illustrated in FIGS. 2 and 3. The configuration of the portable terminal 3 according to the second exemplary embodiment is the same as the configuration of the multifunction apparatus 2 according to the first exemplary embodiment, which is illustrated in FIGS. 4 and 5. The configuration of the cloud 4 according to the second exemplary embodiment is the same as the configuration of the cloud 4 according to the first exemplary embodiment.

### Operation of Second Exemplary Embodiment

An operation of the image printing system 1 according to the second exemplary embodiment will be described below.

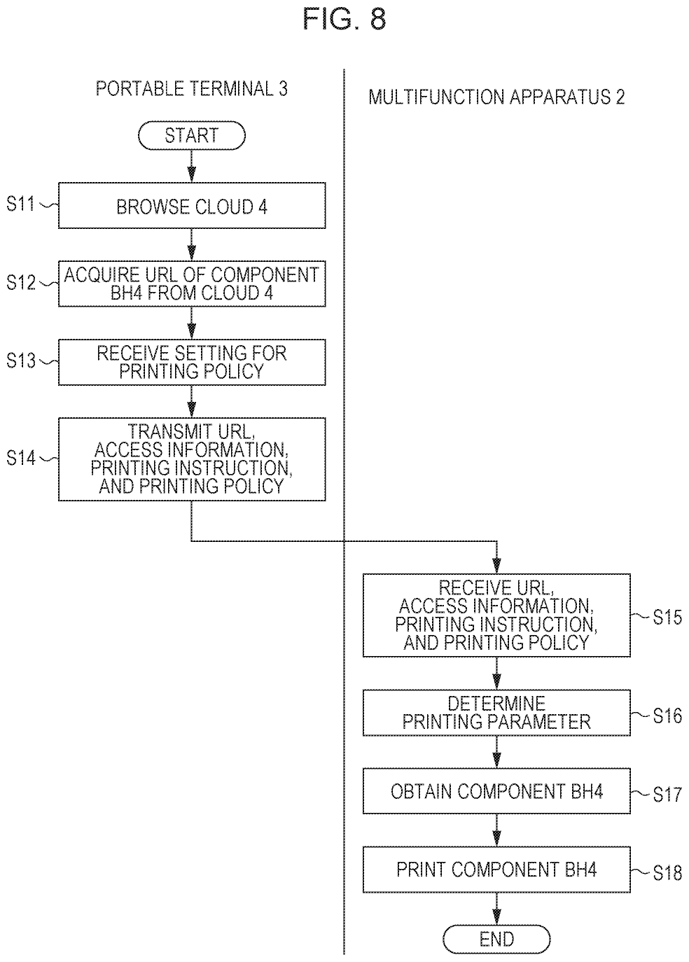

FIG. 8 is a flowchart illustrating the operation of the image printing system according to the second exemplary embodiment. The operation of the image printing system according to the second exemplary embodiment will be described below with reference to the flowchart illustrated in FIG. 8.

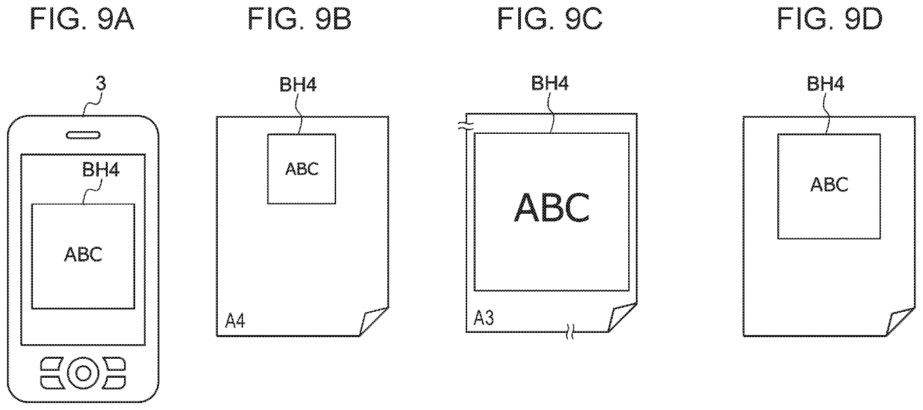

Step S11: As in step S1 described above, in the portable terminal 3, the CPU 3B (illustrated in FIG. 4) functioning as the communication unit 31 (illustrated in FIG. 5) browses the cloud 4 (illustrated in FIG. 1). That is, the CPU 3B accesses the cloud 4 via the browser 3BR (illustrated in FIG. 4), and transmits the URL and access information of the content CN (illustrated in FIGS. 1 and 6), which are input by the user of the portable terminal 3, to the cloud 4. Accordingly, the user of the portable terminal 3 browses the content CN. More accurately, the user of the portable terminal 3 browses characters “ABC”, which are the component BH4, on the screen of a liquid crystal panel, which is the output unit 3C of the portable terminal 3, as illustrated in FIGS. 6 and 9A.

Step S12: As in step S2 described above, the user of the portable terminal 3 issues to the portable terminal 3 an instruction for acquiring the URL of the component BH4. Then, the CPU 3B of the portable terminal 3 functioning as the communication unit 31 (illustrated in FIG. 5) acquires, via the browser 3BR, the URL of the component BH4 from the cloud 4.

Step S13: When the URL of the component BH4 is acquired, the user of the portable terminal 3 inputs to the portable terminal 3 a printing policy for specifying a printing function of the multifunction apparatus 2. In other words, the CPU 3B functioning as the printing policy unit 33 (illustrated in FIG. 5) receives from the user of the portable terminal 3 setting for the printing policy for specifying a printing function of the multifunction apparatus 2.

The “printing policy” represents a general condition, which is common to various multifunction apparatuses and printing apparatuses including the multifunction apparatus 2 according to the second exemplary embodiment, for printing the content CN, the components BH1 to BH5, and the like. Types of printing policy include, for example, (1) print directly (print with the original size), (2) print to fit with the paper size for a multifunction apparatus and a printing apparatus (print to fit with the size of a medium on which printing is to be performed), and (3) print with a physical size for the portable terminal or the like (print with a size displayed on the portable terminal).

When the user of the portable terminal 3 desires to perform printing under the condition (1) mentioned above, the user specifies, at the portable terminal 3, “print directly” as the printing policy.

When the user of the portable terminal 3 desires to perform printing under the condition (2) mentioned above, the user specifies, at the portable terminal 3, “paper size (for example, A4 or A3) on which the multifunction apparatus 2 is to perform printing” and “image sizes (for example, vertical and horizontal lengths of images) of the content CN and the components BH1 to BH5 to be printed” as the printing policy.

When the user of the portable terminal 3 desires to perform printing under the condition (3) mentioned above, the user specifies, at the portable terminal 3, “enlarge or reduce”, “screen size (for example, the number of vertical pixels and the number of horizontal pixels of the screen) of the portable terminal 3”, and “resolution (for example, the number of dots per inch) of the content CN and the components BH1 to BH5” as the printing policy.

Step S14: When reception of setting for the printing policy is completed in step S13, the user of the portable terminal 3 inputs to the portable terminal 3 a printing instruction, which is an instruction for causing the multifunction apparatus 2 to print the component BH4. That is, the input unit 3A of the portable terminal 3 receives the printing instruction from the user of the portable terminal 3. Then, the user of the portable terminal 3 holds the short-range communication unit 32 of the portable terminal 3 (illustrated in FIG. 5) over the short-range communication unit 22 (illustrated in FIG. 3) of the multifunction apparatus 2 (illustrated in FIG. 1). Accordingly, as in the first exemplary embodiment, in the portable terminal 3, the CPU 3B functioning as the short-range communication unit 32 transmits, via the communication application 3CM (illustrated in FIG. 4), the URL of the content CN input by the user of the portable terminal 3, the URL of the component BH4 acquired from the cloud 4, and the access information and printing instruction input by the user of the portable terminal 3 to the multifunction apparatus 2. Moreover, uniquely to the second exemplary embodiment, the printing policy set by the user of the portable terminal 3 is also transmitted to the multifunction apparatus 2.

Step S15: In the multifunction apparatus 2, the CPU 2B (illustrated in FIG. 2) functioning as the short-range communication unit 22 (illustrated in FIG. 3) receives, via the communication application 2CM (illustrated in FIG. 2), the URL of the content CN, the URL of the component BH4, the access information, the printing instruction, and the printing policy from the portable terminal 3.

Step S16: In the multifunction apparatus 2, the CPU 2B functioning as the printing parameter unit 23 (illustrated in FIG. 3) sets, based on the printing policy received from the portable terminal 3, a printing parameter. The “printing parameter” represents an individual condition for printing the content CN, the components BH1 to BH5, and the like, which is unique to the multifunction apparatus 2.

Under the condition (1) mentioned above, that is, in the case where the received printing policy is “print directly”, the CPU 2B determines a printing parameter “print on paper with a size (in many cases, A4 size) set as a default”.

Under the condition (2) mentioned above, that is, in the case where, for example, the received printing policy is “size of paper (A3) on which the multifunction apparatus 2 is to perform printing” and “image size (140 mm×200 mm) of the component BH4”, the CPU 2B determines a printing parameter, for example, for causing the multifunction apparatus 2 to print “the component BH4 at twice the size vertically and horizontally (280 mm×400 mm)” so that the component BH4 may be printed to fit with the paper size of A3 on a “tray accommodating A3 paper (297 mm×420 mm)”.

Under the condition (3) mentioned above, that is, in the case where the received printing policy is, for example, “enlarge (twice the area)”, “screen size (1080×1920 pixels) of the portable terminal 3” and “resolution (300 dpi) of the component BH4”, the CPU 2B determines a printing parameter, for example, for causing the multifunction apparatus 2 to perform printing by “enlarging the vertical and horizontal sizes by 1.41 times” and “with the image size (91 mm×163 mm) of the component BH4”.

The vertical length “91 mm” of the image size of the component BH4 is obtained by calculating 25.4 mm/300 pixels×1080 pixels. The horizontal length “163 mm” is obtained by calculating 25.4 mm/300 pixels×1920 pixels.

Step S17: As in step S5 mentioned above, in the multifunction apparatus 2, the CPU 2B functioning as the communication unit 21 (illustrated in FIG. 3) accesses, via the browser 2BR (illustrated in FIG. 2), the cloud 4 according to the URL of the content CN, the URL of the component BH4, and the access information received from the portable terminal 3, and thus obtains the component BH4 stored in the cloud 4.

Step S18: In the multifunction apparatus 2, the CPU 2B functioning as the printing unit 24 (illustrated in FIG. 3) prints the component BH4 obtained from the cloud 4 in step S17, under the printing instruction received from the portable terminal 3 in step S15, in accordance with the printing parameter determined in step S16.

More particularly, under the condition (1) mentioned above, the CPU 2B prints the component BH4, as illustrated in FIG. 9B in accordance with the printing parameter “paper with a size set as a default (A4)”.

Under the condition (2) mentioned above, the CPU 2B prints the component BH4, as illustrated in FIG. 9C, in accordance with the printing parameter “A3 paper” and “twice the size vertically and horizontally”.

Furthermore, under the condition (3) mentioned above, the CPU 2B prints the component BH4, as illustrated in FIG. 9D, in accordance with the printing parameter “enlarge the vertical and horizontal sizes by 1.41 times” and “image size (91 mm×163 mm)”.

As described above, in the image printing system 1 according to the second exemplary embodiment, as in the first exemplary embodiment, at the portable terminal 3, the short-range communication unit 32 transmits, via the communication application 3CM, the URL of the content CN, the URL of the component BH4, the access information of the content CN, and the printing instruction to the multifunction apparatus 2, and also transmits the printing policy, uniquely to the second exemplary embodiment.

Meanwhile, as in the first exemplary embodiment, at the multifunction apparatus 2, when receiving, via the communication application 2CM, the URL of the content CN, the URL of the component BH4, the access information of the content CN, the printing instruction, and the printing policy, the short-range communication unit 22 prints the component BH4 in accordance with the printing instruction, and according to the printing parameter determined based on the printing policy set by the user of the portable terminal 3, uniquely to the second exemplary embodiment.

Accordingly, there is no need to perform various settings regarding functions of the multifunction apparatus 2 in advance. Furthermore, the component BH4 is printed in a manner intended by the user of the portable terminal 3.

### Modification of Second Exemplary Embodiment

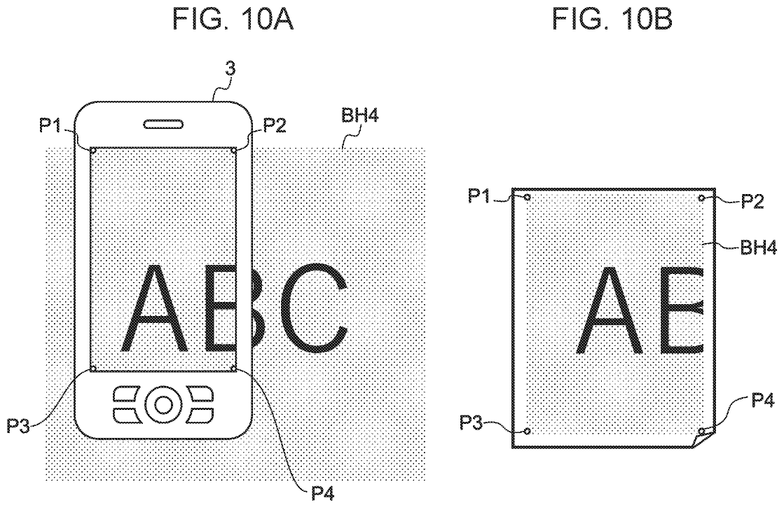

It is assumed that the portable terminal 3 displays an enlarged component BH4, which is illustrated in FIG. 10A, instead of displaying the component BH4 that is not enlarged or reduced, which is illustrated in FIG. 9A, and the condition (3) mentioned above is applied, that is, the printing policy is “print with a physical size for the portable terminal 3”. Based on this assumption, in the portable terminal 3, the short-range communication unit 32 transmits, via the communication application 3CM, for example, coordinates positions of four corner points P1 to P4 of a “part” of the component BH4, which are displayed on the screen of the portable terminal 3, to the multifunction apparatus 2.

Accordingly, in the multifunction apparatus 2, the printing unit 24 prints only the “part” of the component BH4, which is displayed on the screen of the portable terminal 3 illustrated in FIG. 10B, out of the enlarged component BH4 illustrated in FIG. 10A, based on the coordinates positions of the four corner points P1 to P4, instead of printing the “entire” component BH4 illustrated in FIGS. 9B and 9D.

### Modifications of First Exemplary Embodiment and Second Exemplary Embodiment

Regarding communication between the portable terminal 3 and the multifunction apparatus 2 according to the first exemplary embodiment and the second exemplary embodiment described above, the communication application 3CM, the communication application 2CM, and a device driver for the multifunction apparatus 2 may be used, instead of using only the communication application 3CM and the communication application 2CM.

In the portable terminal 3, the short-range communication unit 32 may transmit, for example, via one or both of the communication application 3CM and a device driver (a printer driver for controlling the printing function of the printing unit 24 of the multifunction apparatus 2), the URL of the content CN, the URL of the component BH4, the access information, and the printing instruction.

Furthermore, in the portable terminal 3, the short-range communication unit 32 may transmit, for example, via one or both of the communication application 3CM and a device driver similar to that mentioned above, the URL of the content CN, the URL of the component BH4, the access information, the printing instruction, and the printing policy.

### <Other Modifications>

In the embodiments above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiments above, the term “processor” is broad enough to encompass one processor or plural processors in collaboration which are located physically apart from each other but may work cooperatively.

The order of operations of the processor is not limited to one described in the embodiments above, and may be changed.

In the embodiments above, a program is not necessarily stored (installed) in advance in the storage medium mentioned above. The program may be recorded in a recording medium such as a compact disc-read only memory (CD-ROM), a digital versatile disc read only memory (DVD-ROM), or a universal serial bus (USB) memory and provided. Furthermore, the program may be downloaded via a network from an external apparatus and provided.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image printing system comprising:
a portable terminal and an image printing apparatus,
wherein the portable terminal includes a first processor configured to
transmit, via transmission software that is capable of performing transmission without using a device driver that allows the portable terminal to control a printing function of the image printing apparatus, location information indicating location of content and a printing instruction for printing the content,
wherein the image printing apparatus includes a second processor configured to
receive, via reception software corresponding to the transmission software, the location information and the printing instruction from the portable terminal,
acquire the content identified by the location information, and
print the acquired content in accordance with the printing instruction.

2. The image printing system according to claim 1, wherein the transmission software is mounted on browsing software for browsing the content.

3. The image printing system according to claim 1, wherein the transmission software is externally attached to browsing software for browsing the content.

4. The image printing system according to claim 1,
wherein the first processor is configured to transmit a printing policy for printing the content to the image printing apparatus, and
wherein the second processor is configured to determine a printing parameter with which the image printing apparatus is to perform printing, based on the printing policy received from the portable terminal.

5. The image printing system according to claim 2,
wherein the first processor is configured to transmit a printing policy for printing the content to the image printing apparatus, and
wherein the second processor is configured to determine a printing parameter with which the image printing apparatus is to perform printing, based on the printing policy received from the portable terminal.

6. The image printing system according to claim 3,
wherein the first processor is configured to transmit a printing policy for printing the content to the image printing apparatus, and
wherein the second processor is configured to determine a printing parameter with which the image printing apparatus is to perform printing, based on the printing policy received from the portable terminal.

7. The image printing system according to claim 4, wherein the first processor is configured to transmit, as the printing policy, a condition that the content is printed with an original size.

8. The image printing system according to claim 5, wherein the first processor is configured to transmit, as the printing policy, a condition that the content is printed with an original size.

9. The image printing system according to claim 6, wherein the first processor is configured to transmit, as the printing policy, a condition that the content is printed with an original size.

10. The image printing system according to claim 4, wherein the first processor is configured to transmit, as the printing policy, a condition that the content is printed to fit with a size of a medium on which printing is to be performed.

11. The image printing system according to claim 5, wherein the first processor is configured to transmit, as the printing policy, a condition that the content is printed to fit with a size of a medium on which printing is to be performed.

12. The image printing system according to claim 6, wherein the first processor is configured to transmit, as the printing policy, a condition that the content is printed to fit with a size of a medium on which printing is to be performed.

13. The image printing system according to claim 4, wherein the first processor is configured to transmit, as the printing policy, a condition that the content is printed with a size displayed on the portable terminal.

14. The image printing system according to claim 5, wherein the first processor is configured to transmit, as the printing policy, a condition that the content is printed with a size displayed on the portable terminal.

15. The image printing system according to claim 6, wherein the first processor is configured to transmit, as the printing policy, a condition that the content is printed with a size displayed on the portable terminal.

16. The image printing system according to claim 4,
wherein the first processor is configured to
receive a printing policy specified by a user from among a plurality of different printing policies, and
transmit the received printing policy to the image printing apparatus, and
wherein the second processor is configured to determine a printing parameter with which the image printing apparatus is to perform printing, based on the printing policy received from the portable terminal.

17. The image printing system according to claim 5,
wherein the first processor is configured to
receive a printing policy specified by a user from among a plurality of different printing policies, and
transmit the received printing policy to the image printing apparatus, and
wherein the second processor is configured to determine a printing parameter with which the image printing apparatus is to perform printing, based on the printing policy received from the portable terminal.

18. The image printing system according to claim 6,
wherein the first processor is configured to
receive a printing policy specified by a user from among a plurality of different printing policies, and
transmit the received printing policy to the image printing apparatus, and
wherein the second processor is configured to determine a printing parameter with which the image printing apparatus is to perform printing, based on the printing policy received from the portable terminal.

19. An image printing apparatus comprising:
a first processor configured to
receive, from a second processor provided in a portable terminal, location information indicating location of content and a printing instruction for printing the content that are transmitted via transmission software that is capable of performing transmission without using a device driver for controlling a printing function, via reception software corresponding to the transmission software;
acquire the content identified by the location information, and
print the acquired content in accordance with the printing instruction.

20. A non-transitory computer readable medium storing a program causing a computer to execute a process for image printing, the process comprising:
transmitting, via transmission software that is capable of performing transmission without using a device driver for controlling a printing function, location information indicating location of content and a printing instruction for printing the content,
receiving, via reception software corresponding to the transmission software, the location information and the printing instruction,
acquiring the content identified by the location information, and
printing the acquired content in accordance with the printing instruction.
